(19) United States
(12) Patent Application Publication
(10) Pub. No.: US 2017/0291605 A1
(43) Pub. Date: Oct. 12, 2017

(54) OPTIMIZED FUEL ECONOMY DURING CRUISE CONTROL USING TOPOGRAPHY DATA

(71) Applicant: GM Global Technology Operations LLC, Detroit, MI (US)

(72) Inventors: Amanpal S. Grewal, Novi, MI (US); David E. Homyak, Ann Arbor, MI (US); David C. Muscaro, Commerce Twp, MI (US)

(21) Appl. No.: 15/096,876

(22) Filed: Apr. 12, 2016

(51) Int. Cl. B60W 30/188; B60W 30/14

(52) U.S. Cl. CPC B60W 30/188; B60W 30/143; B60W 2520/10; B60W 2550/143; B60W 2720/10

(57) ABSTRACT

A motor vehicle cruise control system having an input for entering a desired vehicle speed. A vehicle speed deviation having a range both above and below the desired vehicle speed is entered. A memory at least temporarily saves a highway topography data set for a highway currently being traversed by a motor vehicle. A controller distinguishes an approaching highway topography change from a current highway topography condition using data from the highway topography data set; and calculates a modified vehicle speed having increased fuel economy for traversing the highway topography change compared to a fuel economy at a selected vehicle speed for the current highway topography condition and to change the vehicle speed to the modified vehicle speed having the increased fuel economy prior to reaching the upcoming highway topography change.

### FIELD

The present disclosure relates to vehicle cruise control systems, and more particularly to a vehicle cruise control system with topography sensing capability.

### BACKGROUND

The statements in this section merely provide background information related to the present disclosure and may or may not constitute prior art.

Motor vehicle cruise control technology provides closed loop speed control at a desired or “set” vehicle speed which the system attempts to meet regardless of upcoming highway topography, including elevation changes. The driver selected speed is consistently maintained, which requires engine braking during downhill operation and downshifting and increased engine revolutions during uphill operation. Known vehicle cruise control systems also include adaptive cruise control which may provide short distance radar, camera systems, and software for determining when to reduce vehicle speed to match a followed vehicle's speed. Known vehicle cruise control systems are suitable for improving fuel economy for substantially flat highway conditions and for improving driver comfort. Known systems, however, react to highway conditions, but do not optimize fuel economy based on anticipated changes to highway conditions such as gradually rolling conditions which may allow for a modified vehicle speed to further improve fuel economy.

Accordingly, there is room in the art for a vehicle cruise control system that allows driver or predefined conditions to be applied to anticipate upcoming topography changes of the highway which can be used to modify the set vehicle speed, and particularly to optimize fuel economy for the upcoming conditions.

### SUMMARY

The present disclosure provides an example of a motor vehicle cruise control system including a memory at least temporarily saving a highway topography data set for a highway currently being traversed by a motor vehicle. A controller acts to: distinguish an approaching highway topography change from a current highway topography condition using data from the highway topography data set; and calculate a modified vehicle speed having increased fuel economy for traversing the highway topography change compared to a fuel economy at a selected vehicle speed for the current highway topography condition and to change the vehicle speed to the modified vehicle speed having the increased fuel economy prior to reaching the upcoming highway topography change.

In one example of the motor vehicle cruise control system of the present disclosure, a vehicle speed deviation range is selected by an operator of the motor vehicle and input to the controller.

In another example of the motor vehicle cruise control system of the present disclosure, the vehicle speed deviation range includes a first speed higher than the selected vehicle speed and a second speed lower than the selected vehicle speed.

In yet another example of the motor vehicle cruise control system of the present disclosure, the controller is in communication with a GPS database to identify a distance between the motor vehicle and the highway topography change.

In yet another example of the motor vehicle cruise control system of the present disclosure, the controller calculates the most fuel efficient operation for subsequently returning from the modified vehicle speed to the selected speed after the motor vehicle traverses the highway topography change and reaches a substantially flat highway portion.

In yet another example of the motor vehicle cruise control system of the present disclosure, the controller orders a vehicle speed decrease prior to the motor vehicle reaching a downhill portion of the highway.

In yet another example of the motor vehicle cruise control system of the present disclosure, the vehicle speed decrease is bounded by a minimum value of the second speed.

In yet another example of the motor vehicle cruise control system of the present disclosure, the controller orders a vehicle speed increase prior to the motor vehicle reaching an uphill portion of the highway.

In yet another example of the motor vehicle cruise control system of the present disclosure, the vehicle speed increase is bounded by a maximum value of the first speed.

In yet another example of the motor vehicle cruise control system of the present disclosure, the controller of the cruise control system calculates a point on an uphill portion of the highway at which the motor vehicle is allowed to slow below a high speed operating condition down toward the selected speed prior to reaching a crest point of the uphill portion.

In yet another example of the motor vehicle cruise control system of the present disclosure, a non-linear fuel consumption is included in the calculation of the increased fuel economy.

In yet another example of the motor vehicle cruise control system of the present disclosure, a vehicle drag characteristic is included in the calculation of the increased fuel economy.

In yet another example of the motor vehicle cruise control system of the present disclosure, an axle torque is included in the calculation of the increased fuel economy.

In yet another example of the motor vehicle cruise control system of the present disclosure, the vehicle speed deviation range includes one of a speed deviation value above but not below the selected speed, or a speed deviation value below but not above the selected speed.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic showing features of a motor vehicle having a cruise control system according to principles of the present disclosure;

FIG. 2 is a graph identifying specific points along a projected highway travel path of the motor vehicle;

FIG. 3 is a graph of vehicle actual speed compared to a vehicle selected speed;

FIG. 4 is a graph of an exemplary elevational path of a highway saved in a memory of the motor vehicle cruise control system FIG. 1;

FIG. 5 is a graph comparing a fuel economy improvement versus a plurality of vehicle speed deviation values for the motor vehicle cruise control system of the present disclosure;

FIG. 6 is a chart identifying a plurality of exemplary vehicle speed deviation values; and

FIG. 7 is a flowchart providing system characteristics for the motor vehicle cruise control system of the present disclosure.

### DETAILED DESCRIPTION

The following description is merely exemplary in nature and is not intended to limit the present disclosure, application, or uses.

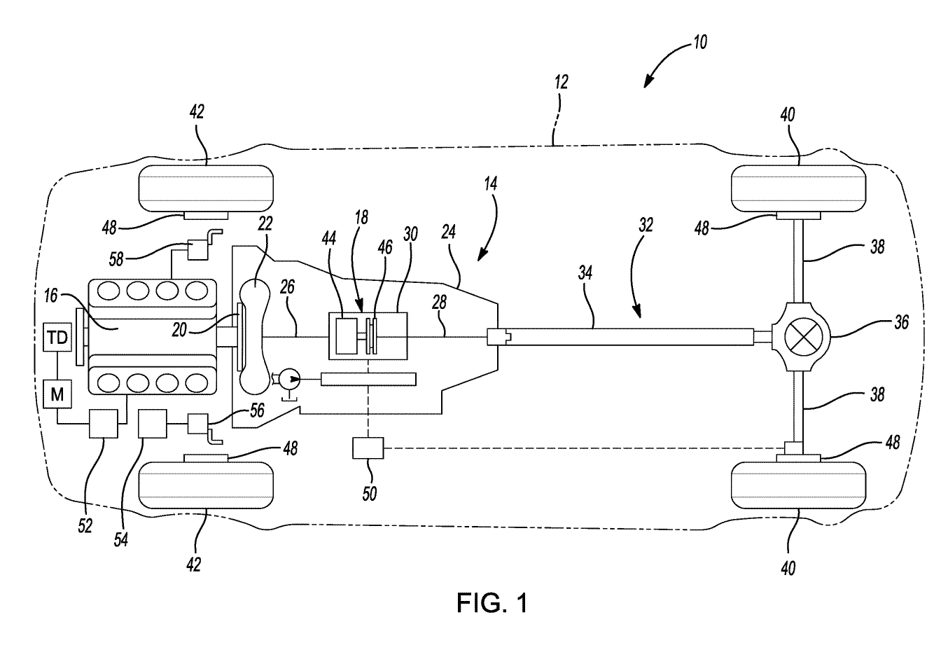

With reference to FIG. 1, a motor vehicle predictive cruise control system 10 is provided for a motor vehicle 12. The motor vehicle 12 is illustrated as a passenger car, but it should be appreciated that the motor vehicle 12 may be any type of vehicle, such as a truck, van, sport-utility vehicle, etc. The motor vehicle 12 includes an exemplary powertrain 14. It should be appreciated at the outset that while a rear-wheel drive powertrain 14 has been illustrated, the motor vehicle 12 may have a front-wheel drive powertrain, a mid-engine powertrain, or an all-wheel drive powertrain without departing from the scope of the present disclosure. The powertrain 14 generally includes an engine 16 interconnected with a transmission 18.

The engine 16 may be a conventional internal combustion engine, an electric motor, a hybrid engine, or any other type of prime mover, without departing from the scope of the present disclosure. The engine 16 supplies a driving torque to the transmission 18 through a flexplate 20 or other connecting device that is connected to a starting device 22. The starting device 22 may be a hydrodynamic device such as a fluid coupling or torque converter, a wet dual clutch, a dry torque damper with springs, or an electric motor. It should be appreciated that any starting device 22 between the engine 16 and the transmission 18 may be employed including a dry launch clutch.

The transmission 18 has a typically cast, metal housing 24 which encloses and protects the various components of the transmission 18. The housing 24 includes a variety of apertures, passageways, shoulders and flanges which position and support these components. Generally speaking, the transmission 18 includes a transmission input shaft 26 and a transmission output shaft 28. Disposed between the transmission input shaft 26 and the transmission output shaft 28 is typically a gear and clutch arrangement 30. The transmission input shaft 26 is functionally interconnected with the engine 16 via the starting device 22 and receives input torque from the engine 16. Accordingly, the transmission input shaft 26 may be a turbine shaft in the case where the starting device 22 is a hydrodynamic device, dual input shafts where the starting device 22 is dual clutch, or a drive shaft where the starting device 22 is an electric motor.

The transmission input shaft 26 is coupled to and provides drive torque to the gear and clutch arrangement 30. For the exemplary rear-wheel drive vehicle shown, the transmission output shaft 28 is connected with a final drive unit 32 which includes, for example, a prop-shaft 34, a differential assembly 36, and drive axles 38 connected to driven wheels 40. Non-driven wheels 42 can also be provided. The gear and clutch arrangement 30 can further include a planetary gear set 44 interconnected by frictional engagement members 46 for application of drive torque to the transmission output shaft 28. Individual brake members 48, which can be provided for example as disc brakes are provided at each of the driven wheels 40 and the non-driven wheels 42.

The motor vehicle 12 can further include a system control module defining a transmission controller 50. The transmission controller 50 is preferably a non-generalized, electronic control device having a preprogrammed digital computer or processor, control logic or circuits, a memory “M” used to store data, and at least one I/O peripheral. The control logic includes or enables a plurality of logic routines for monitoring, manipulating, and generating data and control signals. The controller 50 may be connected to multiple sensors providing input data on transmission operating conditions.

The motor vehicle 12 can also include a system control module or controller 52. The controller 52 is preferably a non-generalized, electronic control device having a preprogrammed digital computer or processor, control logic or circuits, memory “M” used to store data, and at least one I/O peripheral. The control logic includes or enables a plurality of logic routines for monitoring, manipulating, and generating data and control signals for controlling operation of the engine 16, for example through control of an engine throttle control system. According to several aspects, the controller 52 is also in communication with the controller 50 and can therefore also direct operation of the transmission 14.

A hydraulic brake system 54 applies hydraulic braking pressure to stop rotation of any one or each of the driven wheels 40 and the non-driven wheels 42. Braking pressure is provided during normal vehicle operation by manual application of pressure to a brake pedal 56 by the operator of the motor vehicle 12. An accelerator pedal 58 connected to a throttle control system of the engine 16 provides operator control of the engine 16 and is provided to accelerate or decelerate the motor vehicle 12 between a zero speed and a range of operating speeds. The controller 52 can also automatically control the engine 16 during operation of the cruise control system 10. The controller 52 includes memory “M” which can be separated for both RAM and ROM storage of data for operation of the cruise control system 10 and access to global positioning system data to identify the location of the motor vehicle 12 and distances between the motor vehicle 12 and changes in topography of the highway. Such data includes topography data “TD” including elevation and directional changes, local speed limits, and the like for roads and highways accessible by the motor vehicle 12.

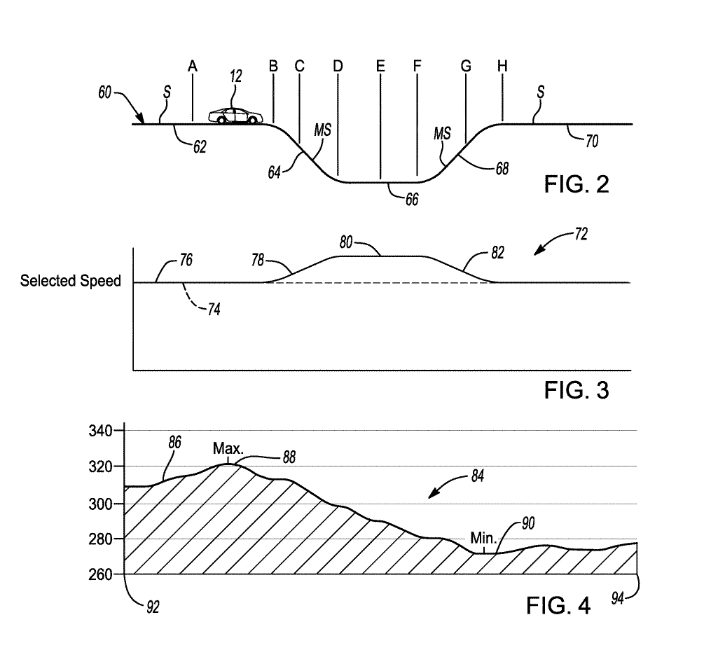

Referring to FIG. 2 and again to FIG. 1, the motor vehicle 12 is depicted during travel along an exemplary highway 60. Highway 60 includes a first level section 62 which transitions into a downhill portion 64, the downhill portion 64 transitioning into a second level section 66, an uphill portion 68 following the second level section 66, and a third level section 70 that follows the uphill portion 68. Initially, the cruise control system 10 is actuated with the motor vehicle 12 set to travel at a vehicle operator selected speed “S” (for example 60 mph) on the first level section 62. The vehicle operator also initially sets a driver selectable speed deviation “SD” which includes a range of speeds, for example +5 mph, −5 mph. The speed deviation “SD” is a difference above and below the selected speed “S” that the vehicle operator considers to be an acceptable window of speeds which will provide a greater window of opportunity for fuel economy savings. According to further aspects, the vehicle operator can select only one of the speed deviation “SD” values, such as a deviation above but not below the selected speed “S”, or a speed deviation “SD” value below but not above the selected speed “S”.

After the vehicle operator initiates operation of the cruise control system 10, enters the selected speed “S”, and enters the speed deviation “SD” values above and below the selected speed “S”, the motor vehicle 12 will generally travel over substantially flat surfaces such as the first level section 62 at the selected speed “S” (in this example 60 mph). Topography data saved as a topography data set “TD” for the specific highway is saved in a database for example as RAM data in controller 52. GPS vehicle location data may be continuously updated by the controller 52 of the motor vehicle 12 and the topography data is applied together with the motor vehicle GPS location data to “look ahead” of the motor vehicle 12 for predicted and known upcoming changes required to the cruise control system conditions to maximize fuel economy based on projected rather than present topography conditions.

At a predetermined distance from a next change in topography, for example at a predetermined distance identified as a point “A” away from the upcoming downhill section 64 the start of which occurs at a point “B”, the controller 52 and the cruise control system 10 calculates from multiple variable engine and vehicle speeds an optimum vehicle speed to maximize fuel economy as the motor vehicle 12 approaches and traverses the downhill portion 64 starting at the point “B”. The predetermined distance defining point “A” and similar forward determined points will vary depending on multiple factors, including actual distance, vehicle speed, the orientation of the highway such as uphill, downhill, or level state, and the time the vehicle will require to change operating speed in the most fuel efficient manner. For example, in order to prevent or minimize vehicle engine braking and corresponding transmission friction member braking or down-shifting while traversing the downhill portion 64, the cruise control system 10 may initiate a gradual reduction in vehicle speed starting at point “A” from the selected speed “S” (60 mph) toward a low speed within the low selected speed deviation “SD” range (in this example −5 mph) such that the motor vehicle 12 will slow down gradually toward a speed of 55 mph as it approaches a point “B” which defines the start of the downhill portion 64. Because vehicle speed has been reduced before or upon reaching the point “B”, the motor vehicle 12 can thereafter gradually increase its speed due to gravity from the lowest speed set by the low speed (55 mph) up to a high speed (65 mph) within the high selected speed deviation “SD” range (in this example +5 mph) such that the motor vehicle 12 will speed up gradually toward 65 mph within the downhill portion 64 to reduce or eliminate transmission gear shifts and engine braking.

As an alternative, such as in the present example, if it is predicted by the calculations performed by the controller 52 of cruise control system 10 that engine braking and shift changes will not be required to maintain vehicle speed at or below the high speed (65 mph) condition during travel down the downhill portion 64, the cruise control system 10 can elect to continue operation at the selected speed “S” (60 mph) until the motor vehicle 12 reaches and enters the downhill portion 64.

As the motor vehicle 12 approaches a point “C” within the downhill portion 64, with the next change in topography upcoming at a point “D” defining a start of the second level section 66, the cruise control system 10 will calculate the optimum operating condition for transitioning into and travel over the second level section 66. In the present example, a point “E” defines a location at which the cruise control system 10 will begin to increase a vehicle speed to account for the vehicle speed decrease anticipated during travel in the upcoming uphill portion 68. If a distance between the point “D” defining the start of the second level section 66 and a point “E” of the second level section 66 does not justify reducing the vehicle speed from the high speed (65 mph) reached at the bottom of the downhill portion 64, the cruise control system 10 may elect to maintain the high speed (65 mph) until the motor vehicle 12 reaches the start of the uphill portion 68 at a point “F”. One advantage of entering the uphill portion 68 at the maximum range or high speed (65 mph) is to minimize shift changes required as the motor vehicle 12 slows down as it traverses the uphill portion 68.

As the motor vehicle 12 traverses the uphill portion 68, the exemplary projected topography data set “TD” indicates that after reaching a crest point “H” of the uphill portion 68, the third level section 70 will follow. Because the motor vehicle speed will return gradually to the selected speed “S” (in this example 60 mph) after reaching the third level section 70, the cruise control system 10 will calculate a point “G” on the uphill portion 68 at which the vehicle should start to slow below the high speed (65 mph) operating condition down toward the selected speed “S” (60 mph), or to slow from the selected speed “S” (60 mph) down toward the low speed (55 mph), without forcing the cruise control system 10 to maintain vehicle speed in a fuel inefficient manner in order to reach the crest point “H” of the uphill portion 68.

As the motor vehicle 12 passes the point “G” heading toward the crest point “H” of the uphill portion 68, the controller 52 of the cruise control system 10 will calculate the most fuel efficient operation for subsequently returning from the present operating speed to the selected speed “S” (60 mph) after the motor vehicle 12 reaches the substantially flat highway portion defined as the third level section 70. In the present example, a gradual reduction in speed from the high speed (65 mph) down to the selected speed “S” (60 mph) will be programmed that provides for either no transmission shifts or minimum shifting.

Referring to FIG. 3 and again to FIGS. 1 and 2, a graph 72 identifies the difference between a substantially flat selected speed (60 mph) curve 74 and a curve defining an actual speed curve 76 of the motor vehicle 12 during travel over the exemplary highway 60. In an increasing speed portion 78, the motor vehicle 12 approaches and traverses the downhill portion 64. A maximum speed portion 80 defines the range over which the motor vehicle 12 travels at the constant high speed (65 mph) allowed by the high selected speed deviation “SD” range (in this example +5 mph). The high speed (65 mph) is achieved just prior to reaching the point “D” in the downhill portion 64, and is retained until after the motor vehicle 12 passes the point “F” and has started up the uphill portion 68. A decreasing speed portion 82 defines the range over which the motor vehicle speed decreases from the maximum allowed high deviation speed (65 mph) back toward the selected speed (60 mph), which continues until after point “H”. The motor vehicle 12 travels once again at the selected speed “S” (60 mph) after passing the point “H” and continuously thereafter along the third level section 70.

Referring to FIG. 4 and again to FIGS. 1 through 2, a graph 84 presents a curve of data points defining an exemplary highway 86 which varies in elevation for example between a maximum elevation 88 and a minimum elevation 90, which are normally data points defining elevations above or below sea level. The highway 86 can be pre-mapped and the data saved for data defining a trip start point 92 and a trip end point 94. This data is available via multiple online or purchased mapping or GPS data sources and can be downloaded and saved in a memory “M” of the cruise control system 10, or uploaded as needed at the start of, or during a vehicle trip.

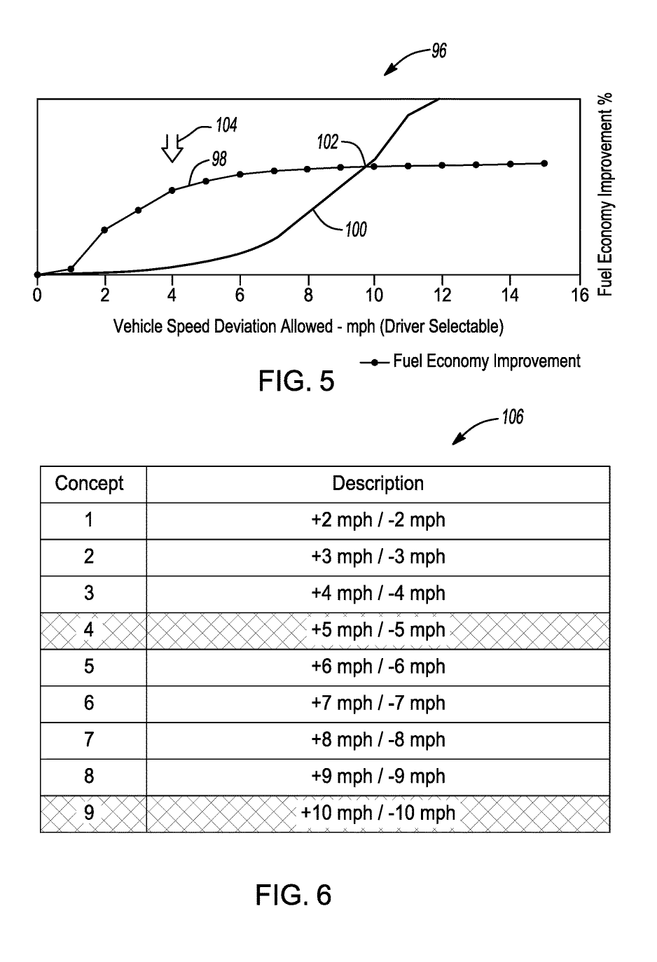

Referring to FIG. 5 and again to FIG. 4, a graph 96 identifies a curve 98 defining fuel economy improvement expressed as a percentage versus a curve 100 representing the vehicle speed deviation “SD” values ranging between zero and 15 mph. Testing indicates a crossover point 102 occurs beyond which substantially no further fuel economy savings are expected at higher selected speed deviation “SD” values. It is anticipated that an optimum point 104 may be predetermined, for example approximately 80% of the maximum fuel economy savings can be obtained using a lower speed deviation “SD” value of 4 mph. The optimum point 104 can be provided to the vehicle operator as a recommended value, or the vehicle operator can also be allowed to select any value for speed deviation “SD” which is comfortable for vehicle operation.

Referring to FIG. 6 and again to FIGS. 1 through 5, a table 106 provides exemplary concepts 1-9 depicting possible ranges of speed deviation “SD” values. It is noted that speed deviation “SD” values outside of these ranges can also be selected, for example having different high and low ranges, such as +3 mph/−5 mph. While higher speed deviation “SD” values are indicated to provide the maximum fuel economy savings, vehicle operator comfort may be optimum at lower ranges. For example some vehicle operators may prefer a cruise control operating range that varies by less than 20 mph. It is for this reason the vehicle operator is given the option of inputting their own speed deviation “SD” range values together with a selected speed.

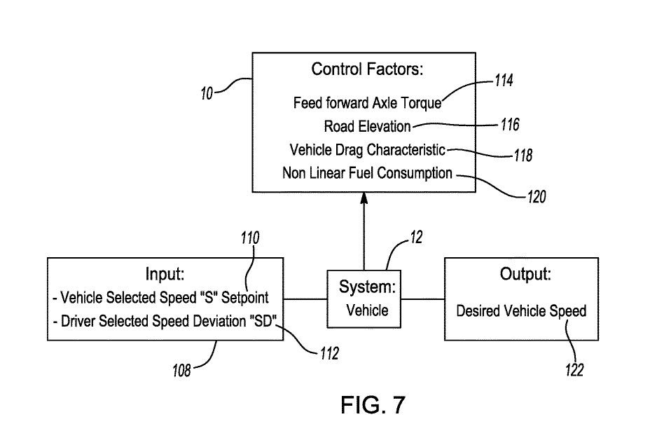

Referring to FIG. 7 and again to FIG. 1, in an input step 108, the vehicle operator inputs the vehicle selected speed “S” in a vehicle speed setpoint selector and the speed deviation “SD” range as a driver selected speed deviation “SD” selector 112. The cruise control system 10 applies various control factors to determine an optimum fuel economy during calculation of the optimum fuel economy and therefore an optimum vehicle operating speed range by applying a feedforward axle torque 114, a road elevation 116, a vehicle drag characteristic 118, and applies a non-linear fuel consumption 120. Using these input values and system criteria, the selected or desired vehicle speed 122 is the output from the cruise control system 10.

The cruise control system 10 of the present disclosure differs from standard vehicle cruise control systems by performing calculations to optimize fuel economy and change a vehicle engine setting or speed in advance of reaching a change in a highway topography. This proactive approach replaces the “reactive” system used by common vehicle cruise control systems to reduce the use of engine braking, transmission shifts, and engine speed changes to control vehicle speed. The cruise control system 10 of the present disclosure also allows the vehicle operator to select between different ranges of maximum and minimum operating speeds that the vehicle will reach during system operation, which further enhances fuel economy savings.

It should also be appreciated that the cruise control system 10 of the present disclosure may have other configurations, such as being applicable for use with a manual transmission, a hybrid vehicle, and electric motor operated vehicles. Modifications with respect to the speed selection and speed deviation “SD” ranges can also be made without departing from the scope of the present disclosure. Depending on the level of allowed speed deviation “SD” and road grade profile, the cruise control system 10 of the present disclosure will provide enhanced fuel economy benefits. Further, the cruise control system of the present disclosure will provide a reduction in gear shifts, AFM transitions, DFCO events, load changes, brake applications (reducing brake wear) and torque reversals to provide improved vehicle durability.

Using known topography, a cruise control system will be used to take advantage of the driving road grade profile. Driver selected allowed speed deviation “SD” will define limits of permitted vehicle speed error. Maximum benefits will be realized on gradual grades. On gradually rolling grades, this system will provide significant fuel economy benefits and enhanced durability.

According to several aspects of the present disclosure, a motor vehicle cruise control system 10 includes an input 110 for entering a desired vehicle speed; an input 112 for entering a vehicle speed deviation “SD” having a range both above and below the desired vehicle speed; and a memory “M” at least temporarily saving a highway topography data set “TD” for a highway currently being traversed by a motor vehicle 12. A controller 52 acts to: distinguish an approaching highway topography change (B, C, F, G) from a current highway topography condition “A” using data from the highway topography data set “TD”; and calculate a modified vehicle speed “MS” having increased fuel economy for traversing the highway topography change (B, C, F, G) compared to a fuel economy at a selected vehicle speed “S” for the current highway topography condition “A” and to change the vehicle speed to the modified vehicle speed “MS” having the increased fuel economy prior to reaching the upcoming highway topography change.

The description of the invention is merely exemplary in nature and variations that do not depart from the general gist of the invention are intended to be within the scope of the invention. Such variations are not to be regarded as a departure from the spirit and scope of the invention.

What is claimed is:

1. A motor vehicle cruise control system, comprising:
a memory at least temporarily saving a highway topography data set for a highway currently being traversed by a motor vehicle;
a controller acting to:
distinguish an approaching highway topography change from a current highway topography condition using data from the highway topography data set; and
calculate a modified vehicle speed having increased fuel economy for traversing the highway topography change compared to a fuel economy at a selected vehicle speed for the current highway topography condition and to change the vehicle speed to the modified vehicle speed having the increased fuel economy prior to reaching the upcoming highway topography change.

2. The motor vehicle cruise control system of claim 1, further including a vehicle speed deviation range selected by an operator of the motor vehicle and input to the controller.

3. The motor vehicle cruise control system of claim 2, wherein the vehicle speed deviation range includes a first speed higher than the selected vehicle speed and a second speed lower than the selected vehicle speed.

4. The motor vehicle cruise control system of claim 1, wherein the controller is in communication with a GPS database to identify a distance between the motor vehicle and the highway topography change.

5. The motor vehicle cruise control system of claim 1, wherein the controller calculates the most fuel efficient operation for subsequently returning from the modified vehicle speed to the selected speed after the motor vehicle traverses the highway topography change and reaches a substantially flat highway portion.

6. The motor vehicle cruise control system of claim 3, wherein the controller orders a vehicle speed decrease prior to the motor vehicle reaching a downhill portion of the highway.

7. The motor vehicle cruise control system of claim 6, wherein the vehicle speed decrease is bounded by a minimum value of the second speed.

8. The motor vehicle cruise control system of claim 3, wherein the controller orders a vehicle speed increase prior to the motor vehicle reaching an uphill portion of the highway.

9. The motor vehicle cruise control system of claim 8, wherein the vehicle speed increase is bounded by a maximum value of the first speed.

10. The motor vehicle cruise control system of claim 8, wherein the controller of the cruise control system calculates a point on an uphill portion of the highway at which the motor vehicle is allowed to slow below a high speed operating condition down toward the selected speed prior to reaching a crest point of the uphill portion.

11. The motor vehicle cruise control system of claim 1, wherein a non-linear fuel consumption is included in the calculation of the increased fuel economy.

12. The motor vehicle cruise control system of claim 1, wherein a vehicle drag characteristic is included in the calculation of the increased fuel economy.

13. The motor vehicle cruise control system of claim 1, wherein an axle torque is included in the calculation of the increased fuel economy.

14. The motor vehicle cruise control system of claim 2, wherein the vehicle speed deviation “SD” range includes one of a speed deviation “SD” value above but not below the selected speed, or a speed deviation “SD” value below but not above the selected speed.

15. A motor vehicle cruise control system, comprising:
an input for entering a desired vehicle speed;
an input for entering a vehicle speed deviation having a range both above and below the desired vehicle speed;
a memory at least temporarily saving a highway topography data set for a highway currently being traversed by a motor vehicle; and
a controller acting to:
distinguish an approaching highway topography change from a current highway topography condition using data from the highway topography data set; and
calculate a modified vehicle speed having increased fuel economy for traversing the highway topography change compared to a fuel economy at a selected vehicle speed for the current highway topography condition and to change the vehicle speed to the modified vehicle speed having the increased fuel economy prior to reaching the upcoming highway topography change.

16. The motor vehicle cruise control system of claim 15, further including:
a vehicle speed deviation range selected by an operator of the motor vehicle and input to the controller; and
the vehicle speed deviation range includes a first speed higher than the selected vehicle speed and a second speed lower than the selected vehicle speed.

17. The motor vehicle cruise control system of claim 16, wherein:
the controller orders a vehicle speed decrease prior to the motor vehicle reaching a downhill portion of the highway; and
the vehicle speed decrease is bounded by a minimum value of the second speed.

18. The motor vehicle cruise control system of claim 16, wherein:
the controller orders a vehicle speed increase prior to the motor vehicle reaching an uphill portion of the highway; and
the vehicle speed increase is bounded by a maximum value of the first speed.

19. The motor vehicle cruise control system of claim 15, wherein the the calculation of the modified vehicle speed having increased fuel economy includes:
a non-linear fuel consumption;
a vehicle drag characteristic; and
an axle torque.

20. A method for using a cruise control system for improving energy efficient operation of a motor vehicle, comprising:
inputting a desired vehicle speed;
entering a vehicle speed deviation having a range both above and below the desired vehicle speed;
saving in a memory a highway topography data set for a highway currently being traversed by a motor vehicle;
actuating a controller to distinguish an approaching highway topography change from a current highway topography condition using data from the highway topography data set;
calculating a modified vehicle speed having increased fuel economy for traversing the highway topography change compared to a fuel economy at a selected vehicle speed for the current highway topography condition; and
changing the vehicle speed to the modified vehicle speed having the increased fuel economy prior to reaching the upcoming highway topography change.
